(19) United States
(12) Patent Application Publication
(10) Pub. No.: US 2017/0161821 A1
(43) Pub. Date: Jun. 8, 2017

(54) Store Message Integration System and Method for Using the Same

(71) Applicant: Hometouch Co., Ltd., New Taipei City 231 (TW)

(72) Inventor: Chieh-Fa Wang, New Taipei City (TW)

(21) Appl. No.: 15/260,401

(22) Filed: Sep. 9, 2016

(30) Foreign Application Priority Data
Dec. 4, 2015 (TW) 104140702

(51) Int. Cl. G06Q 30/06; G06Q 40/04

(52) U.S. Cl. CPC G06Q 30/0641; G06Q 40/04; G06Q 30/0623; H04L 67/02

(57) ABSTRACT

A store message integration system and method for using the same are provided. The stores message integration system includes a message integration platform and a message operating module. The messages integration platform includes a store coding list and a plurality of store message lists. The store coding list includes a plurality of store codes corresponding to the store message lists. The message operating module includes an inputting unit, a processing unit and a transmitting unit. The inputting unit is configured to enter an instruction. The processing unit receives the instruction in order to generate a request signal. The request signal is transmitted via the transmitting unit for connecting to the message integration platform. The instruction is one of the store codes. The message operating module receives the store message lists from the message integration platform according to the instruction and the store coding list.

### FIELD OF THE INVENTION

The invention relates to a store message integration system and a method for using the same, and more particularly relates to a store message integration system and method for using the same including a message operating module.

### BACKGROUND OF THE INVENTION

In this digital era, Network Technology makes people's lives more comfortable and convenient. For example, a consumer could buy required goods on the Internet. The convenience of online shopping let the consumer gradually change consumption habits.

Generally, when the consumer wants to make a purchase, the consumer needs to connect to a web page of a store to find needed goods, or the consumer would download an app of the store from App Store or Google Play with a smart phone or a tablet. However, if the consumer favors various stores, the consumer must download the multiple Apps corresponding to the stores one by one, and it is very inconvenient.

### SUMMARY OF THE INVENTION

One object of the present invention is to provide a store message integration system and a method for using the same. The store message integration system and the method for using the same can integrate a plurality of information of stores, so the consumer can find the needed goods easily. Moreover, the store message integration system further offers a shopping service.

A store message integration system is provided. The store message integration system includes a message integration platform and a message operating module. The message integration platform includes a store coding list and a plurality of store message lists, wherein the store coding list includes a plurality of store codes. The store codes correspond to the store message lists. The message operating module includes an inputting unit, a processing unit and a transmitting unit. The inputting unit is used to enter a first instruction. The processing unit is connected to the inputting unit and the processing unit receives the first instruction in order to generate a linking request signal. The transmitting unit is connected to the processing unit, and the transmitting unit transmits the linking request signal in order to connect to the message integration platform. Wherein the first instruction is one of the store codes, and the message operating module receives the store message list from the message integration platform according to the first instruction and the store coding list.

### BRIEF DESCRIPTION OF THE DRAWINGS

FIG. 1 illustrates a schematic diagram of a store message integration system in accordance with an embodiment of the present invention;

FIG. 2A illustrates a schematic diagram of the store message integration system in accordance with another embodiment of the present invention;

FIG. 2B illustrates another schematic diagram of the store message integration system of FIG. 2A; and

FIG. 3 illustrates a flow diagram of a method for using the store message integration system.

### DETAILED DESCRIPTION OF PREFERRED EMBODIMENTS

The foregoing, as well as additional objects, features and advantages of the invention will be more readily apparent from the following detailed description, which proceeds with reference to the accompanying drawings.

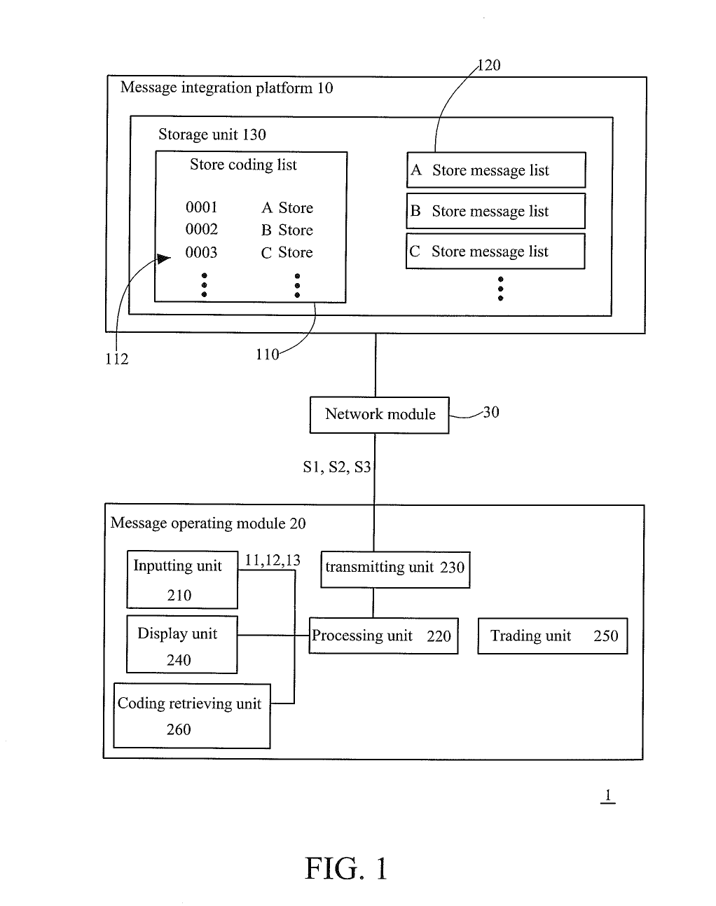

Please refer to FIG. 1. FIG. 1 illustrates a schematic diagram of a store message integration system in accordance with an embodiment of the present invention. The store message integration system 1 includes a message integration platform 10 and a message operating module 20. In the embodiment of the present invention, the message integration platform 10 includes a store coding list 110 and a plurality of store message lists 120. The store coding list 110 includes a plurality of store codes 112 corresponding to the store message lists 120. The message operating module 20 includes an inputting unit 210, a processing unit 220 and a transmitting unit 230. The processing unit 220 is connected to the inputting unit 210, and the transmitting unit 230 is also connected to the processing unit 220.

Moreover, the message operating module 20 further includes a display unit 240, a trading unit 250 and a coding retrieving unit 260. The display unit 240 is connected to the processing unit 220 and shows an information of the message integration platform 10. In addition, the trading unit 250 and the coding retrieving unit 260 are connected to the processing unit 220.

From the above, the message operating module 20 is a mobile electronic device and the inputting unit 210 is a button or a touch screen.

Therefore, the consumer could enter the first instruction I1 via the inputting unit 210. The first instruction I1 is received by the processing unit 220 in order to generate a linking request signal S1. As a result, the transmitting unit 230 could transmit the linking request signal S1 in order to connect to the message integration platform 10. Furthermore, the first instruction I1 includes one of the store codes 112. The message operating module 20 receives the store message list 120 from the message integration platform 10 according to the first instruction I1 and the store message list 110. Specifically, the consumer could directly enter the store code 122 to connect to a web page of a store.

In addition, the message integration platform 10 further includes a storage unit 130. The store message list 110 and a plurality of the store message lists 120 are stored in the storage unit 130. When the consumer wants to know specific store information, inputting the store code 112 via the inputting unit 210, and the transmitting unit 230 would transmit linking request signal S1 in order to connect to the message integration platform 10. The message operating module 20 would receive the store message lists 120 that the consumer wants to know via the store message list 110. The store message list 120 includes a product information and a payment information that could be browsed by the consumers, and the consumers could directly pay money after their purchasing.

Moreover, the store message integration system 1 further includes a network module 30. The message integration platform 20 disposed outside the message operating module. The message integration platform 20 is an external message integration platform. For example, the message integration platform 20 is disposed at a remote location. Therefore, the message operating module 20 is connected to the message integration platform 10 via the network module 30. Specifically, when the consumer directly enters the store code 112 via the inputting unit 210, the message integration platform 20 is connected to the message integration platform 10 of the remote location via the network module 30 so that the message integration platform 10 receives the store message lists 120 including a product information and a payment information, and the product information and the payment information are shown on the display unit 240 in order to be browsed by the consumer.

Moreover, the inputting unit 210 could be inputted a second instruction I2. The processing unit 220 and the trading unit 250 could receive the second instruction I2 in order to generate a trading request signal S2. The trading request signal S2 is transmitted to the message integration platform 10 via the transmitting unit 230. The message integration platform 10 deals with the trading request signal S1. Specifically, when the consumer browses the product information and wants to buy the product, the consumer can enter the second instruction I2 in accordance with the payment information. Afterward, the trading request signal S2 is transmitted to the message integration platform 10 for dealing with a trading operation.

Furthermore, if the consumer does not know a store code 112 of a specific store, the consumer can use a searchable way to find the store code 112 of the specific store. Specifically, the consumer could enter a third instruction I3 including a merchant name via the inputting unit 210.

The processing unit 220 and the coding retrieving unit 260 could receive the third instruction I3 in order to generate a coding retrieving request signal S3. The coding retrieving request signal S3 is transmitted to the message integration platform 10 via the transmitting unit 230. The message integration platform 20 could download the retrieved store code 112 via information of the store message list 110. The retrieved store code 112 is shown on the display unit 240. In addition, the consumer could use the retrieved store code 112 to connect to the message integration platform 10.

From the above, the trading request signal S2 and the coding retrieving request signal S3 could be transmit to the message integration platform 10 via the network module 30.

In the present invention, the message integration platform 20 is not only a smart phone, a tablet or a notebook but also is a combination of a television and a remote control. For example, the display unit 240 is disposed at the television and the inputting unit 210 is disposed at the remote control, the inputting unit 210 such as buttons of the remote control. As a result, the consumer could use the inputting unit 210 of the remote control to show the product information downloaded on the television. In addition, the consumer could also use the remote control to make a purchase when the consumer watches a shopping channel.

In the present invention, the store message list 120 not only includes a product information and a payment information but also includes a specific web page address. Specifically, when the message integration platform 10 receives the store message lists 120 including the specific web page address, the processing unit 220 can deal with the specific web page address and directly enter an information page of the specific store via the network module 30 in order to browse the product information or make a purchase.

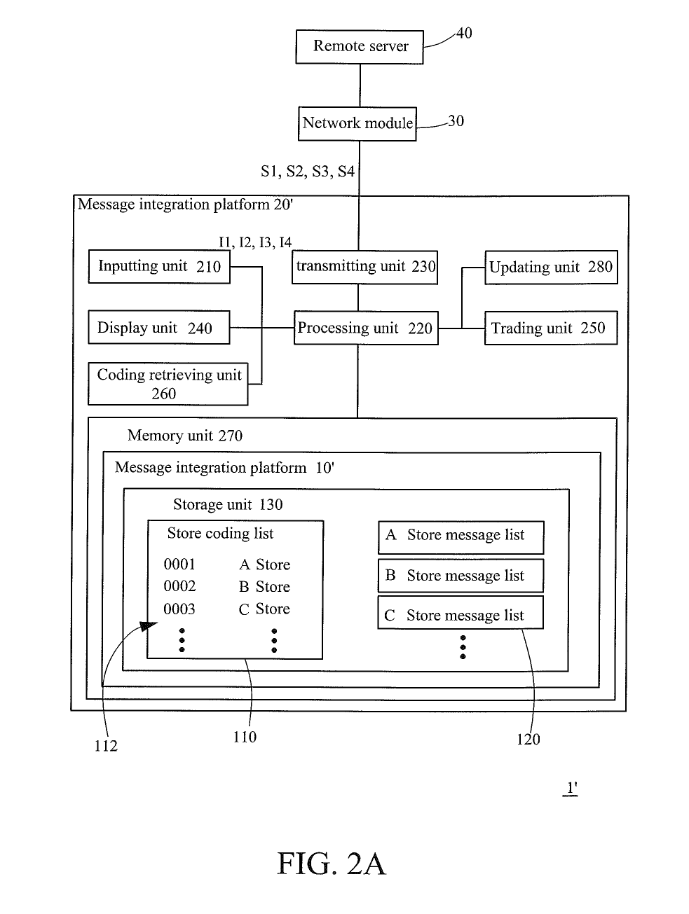

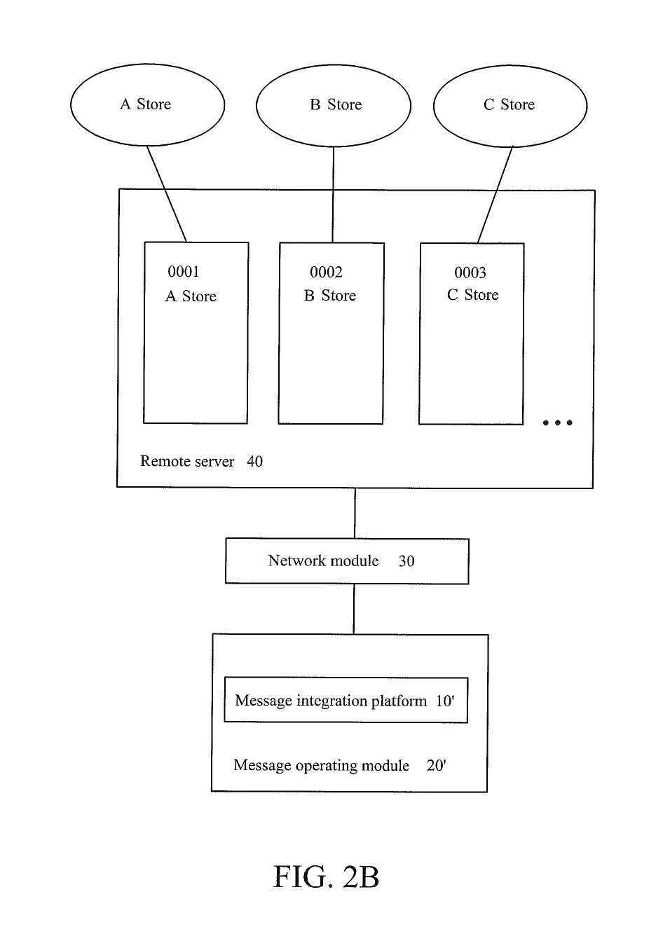

FIG. 2A illustrates a schematic diagram of the store message integration system 1′ in accordance with another embodiment of the present invention. FIG. 2B illustrates another schematic diagram of the store message integration system 1′ of FIG. 2A. Please refer to FIG. 2A and FIG. 2B, the store message integration system 1′ is similar to the store message integration system 1. The difference is that the message integration platform 10′ of the store message integration system 1′ is an embedded message integration platform. The message integration platform 10′ is embedded in the message operating module 20′. It is worth mentioning that a combination of the message integration platform 10′ and the message operating module 20′ is a smart phone, a tablet, a notebook, or other portable electronic devices. In addition, the combination of the message integration platform 10′ and the message operating module 20′ could be a remote control including a display function and touch function.

Furthermore, the message operating module 20′ further includes a memory unit 270. The memory unit 270 is connected to the processing unit 220. The message integration platform 10′ is embedded in the memory unit 270. In addition, the store message integration system 1′ not only includes a network module 30 but also includes a remote server 40. The message operating module 20′ further includes an updating unit 280 connected to the processing unit 220. It is worth mentioning that the inputting unit 210 could be entered a fourth instruction I4 by the consumer. The processing unit 220 and the updating unit 280 could receive the fourth instruction I4 in order to generate a message updating request signal S4. The message updating request signal S4 is transmitted to the network module 30 via the transmitting unit 230. Afterward, the message updating request signal S4 is transmitted to the remote server 40 in order to update information of the embedded message integration platform 10′. Furthermore, the message integration platform 10′ is embedded in the message operating module and is an embedded message integration platform. Therefore, that the consumer enters the first instruction I1, the second instruction I2 and the third instruction I3 via inputting unit 210 directly reads the message integration platform 10′ of the memory unit 270. Specifically, the message integration platform 10 directly reads internal information of message operating module 20. As a result, when there is no network connection the consumer could also browse the product information of the store. In other words, the network module 30 and the remote server 40 are selective elements. Any technique of entering the store code by the message operating module to get the store message list is belonging to the spirit and scope of the present invention without any limitation.

Moreover, before the consumer browses the product information or makes a purchase, the consumer can run a message update job in order that the message integration platform 10′ of the memory unit 270 has the latest store coding list 110 and a plurality of store message lists 120. Therefore, the message integration platform 10′ includes the latest product information.

From the above, the remote server 40 storages the latest store coding list 110 and the plurality of store message lists 120 in order that the consumer can run an update operation from time to time.

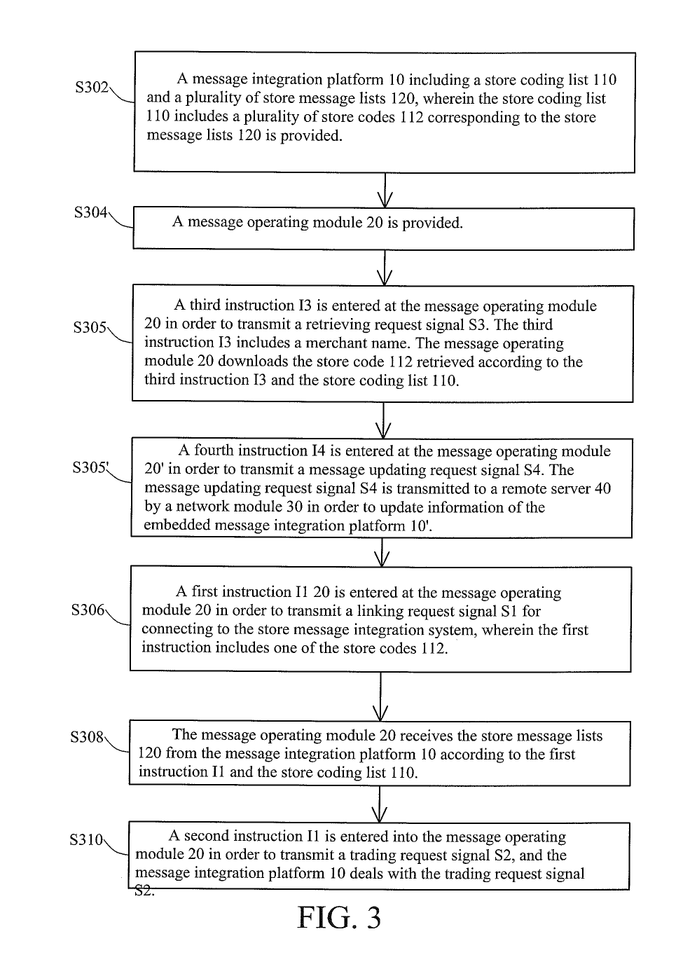

Furthermore, the combination of the message integration platform 10′ and the message operating module 20′ could directly connect to an exclusive website of the store via the latest store coding list 110 and the plurality of store message lists 120 in the remote server 40. The exclusive website is made by the store. FIG. 3 illustrates a flow diagram of a method for using the store message integration system. Please refer to FIG. 3. The method for using a store message integration system comprising the steps of: first, as described in the step S302, a message integration platform 10 including a store coding list 110 and a plurality of store message lists 120 is provided, and the store coding list 110 includes a plurality of store codes 112 corresponding to the store message lists 120. Next, as described in the step S304, a message operating module 20 is provided.

Next, as described in the step S306, a first instruction I1 20 is entered into the message operating module 20 in order to transmit a linking request signal S1 for connecting to the store message integration system, wherein the first instruction includes one of the store codes 112. Next, as described in the step S308, the message operating module 20 receives the store message lists 120 from the message platform 10 according to the first instruction I1 and the store coding list 110.

Next, as described in the step S310, a second instruction I1 is entered into the message operating module 20 in order to transmit a trading request signal S2, and the message integration platform 10 deals with the trading request signal S2. In addition, after the step S310, the display unit 240 could display a product information and a payment information of the store message list 120. After the step S308, the display unit 240 could directly display the product information of the store message list 120.

In a preferred embodiment, the consumer carries out the step S305 before the step 5306. As described in step S305, a third instruction I3 is entered into the message operating module 20 in order to transmit a retrieving request signal S3. The third instruction I3 includes a merchant name. The message operating module 20 downloads the retrieved store code 112 according to the third instruction I3 and the store coding list 110.

Furthermore, when the message integration platform 10′ is an embedded message integration platform, the consumer carries out the step S305′ before the step S306. As described in step S305′, a fourth instruction I4 is entered into the message operating module 20′ in order to transmit a message updating request signal S4. The message updating request signal is S4 is transmitted to a remote server 40 via a network module 30 in order to update information of the embedded message integration platform 10′.

In summary, the present invention integrates a plurality of information of stores into the store message integration system. The consumer could use a message operating module of the mobile electronic device to get the store message. The consumer could connect to a web page of every store easily. Especially, as long as the consumer barely enters the store code, the consumer can connect to the web page of store. The present invention includes exclusive spaces to offer to the store not including exclusive website for the consumer to browse the product information or make a purchase. Moreover, the present invention integrates a plurality of information of stores, so the consumer can browse it easily. As a result, that the information of stores is browsed is increased and visibility of goods of stores is also increased.

Furthermore, no matter what the message integration platform is an outside message integration platform or an embedded message integration platform, the present invention offers the consumer the information of stores that is direct and convenient in order that consumption activities of the consumer is efficient.

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

What is claimed is:

1. A store message integration system comprising:
a message integration platform including a store coding list and a plurality of store message lists, wherein the store coding list includes a plurality of store codes corresponding to the store message lists;
a message operating module comprising:
an inputting unit used to enter a first instruction;
a processing unit connected to the inputting unit and receiving the first instruction in order to generate a linking request signal; and
a transmitting unit connected to the processing unit and transmitting the linking request signal in order to connect the message integration platform;
wherein the first instruction is one of the store codes, the message operating module receives the store message list from the message integration platform according to the first instruction and the store coding list.

2. The store message integration system of claim 1 further comprising a network module, wherein the message integration platform is an external message integration platform, the message integration platform is disposed external the message operating module, and the message operating module is connected to the message integration platform via the network module.

3. The store message integration system of claim 1, wherein the message operating module further includes a display unit connected to the processing unit and show an information of the message integration platform on the display unit.

4. The store message integration system of claim 3, wherein the message operating module further includes a trading unit connected to the processing unit, the inputting unit is used to enter a second instruction, the processing unit and the trading unit receives the second instruction in order to generate a trading request signal, the trading request signal is transmitted to the message integration platform, and the message integration platform deals with the trading request signal.

5. The store message integration system of claim 3, wherein the message operating module further includes a coding retrieving unit connected to the processing unit, the inputting unit is used to enter a third instruction, the processing unit and the coding retrieving unit receive the third instruction in order to generate a coding retrieving request signal, the third instruction includes a merchant name, and the coding request signal is transmitted to the message integration platform in order to download the store code retrieved and show the store code on the display unit.

6. The store message integration system of claim 3, wherein the message operating module is composed of a television and a remote control, the display unit is disposed at the television, and the inputting unit is disposed at the remote control.

7. The store message integration system of claim 3, wherein the message operating module is a mobile electronic device and the inputting unit is a button or a touch screen.

8. The store message integration system of claim 1, wherein the message integration platform further includes a storage unit storing the store coding list and store message list, and the store message list includes a product information and a payment information.

9. The store message integration system of claim 1, wherein the store message list includes a specific web page address.

10. The store message integration system of claim 1, wherein the message integration platform is an embedded message integration platform, and the message integration platform is embedded in the message operating module.

11. The store message integration system of claim 10, wherein the message operating module includes a memory unit connected to the processing unit, and the message integration platform is embedded in the memory unit.

12. The store message integration system of claim 10 further comprising a network module and a remote server, the message operating module further including an updating unit connected to the processing unit, the inputting unit used to enter a fourth instruction, the processing unit and the updating unit receiving the fourth instruction in order to generate a message updating request signal, the message updating request signal transmitted to the network module and the remote server via the transmitting unit in order to update an information of the embedded message integration platform.

13. A method for using a store message integration system comprising:
providing a message integration platform including a store coding list and a plurality of store message lists, wherein the store coding list includes a plurality of store codes corresponding to the store message lists;
providing a message operating module;
entering a first instruction at the message operating module to transmit a linking request signal in order to connect the store message integration system, wherein the first instruction is one of the store codes;
and the message operating module receiving the store message lists from the message integration platform according to the first instruction and the store coding list.

14. The method for using the store message integration system of claim 13, wherein when the message operating module receives the store message list, a second instruction is entered into the message operating module in order to transmit a trading request signal, and the message integration platform deals with the trading request signal.

15. The method for using the store message integration system of claim 13, wherein before the first instruction is entered into the message operating module, the third instruction is entered into the message operating module in order to transmit a coding retrieving request signal, and the third instruction includes a merchant name, and the message operating module downloads the store code retrieved according to the third instruction and the store coding list.

16. The method for using the store message integration system of claim 13, wherein the store message list includes a product information and a payment information, and the message operating module includes a display unit; wherein when the message operating module receives the store message list, and the product information and the payment information of the store message list are shown on the display unit.

17. The method for using the store message integration system of claim 13, wherein the store message list includes a specific web page address, and when the message operating module receives the store message list, the specific web page address of the store message list is executed.

18. The method for using the store message integration system of claim 13, wherein the message integration platform is an external message integration platform, the message integration platform is disposed outside the message operating module, and the message operating module is connected to the message integration platform via a network module.

19. The method for using the store message integration system of claim 13, wherein the message integration platform is an embedded message integration platform, and the message integration platform is embedded in the message operating module; wherein before the first instruction is entered into the message operating module, the method for using the store message integration system comprising:
entering the fourth instruction to the message operating module in order to transmit a message updating request signal; and
transmitting the message updating request signal to a remote server via a network module in order to update information of the embedded message integration platform.

21. The method for using the store message integration system of claim 13, wherein the message operating module includes an inputting unit, a transmitting unit and a processing unit, the processing unit connected to the inputting unit and the transmitting unit; wherein the inputting unit is used to enter a first instruction, and the processing unit is used to receive the first instruction in order to generate a linking request signal; wherein the transmitting unit transmits the linking request signal in order to connect to the message integration platform.
